(19) United States
(12) Patent Application Publication
(10) Pub. No.: US 2011/0192911 A1
(43) Pub. Date: Aug. 11, 2011

(54) Wearable pest repellant for people and pets

(76) Inventor: Ralph Wayne Bevins, Murphy, NC (US)

(21) Appl. No.: 12/701,276

(22) Filed: Feb. 5, 2010

(51) Int. Cl. A01N 25/08; B65B 1/04

(52) U.S. Cl. 239/36; 53/467

(57) ABSTRACT

A Wearable pouch for people and pets includes absorbing beads, corn cob, pulverized dried wood, gel, corn starch, or plastic pellets, coated with dried or liquid citronella oil, a pouch, containing the absorbing material, a fastener, adapted to fasten the pouch shut, or surge closed; a grommet on the pouch; a carrying member, which threads through grommet or fastener; resealable packaging; and a label.

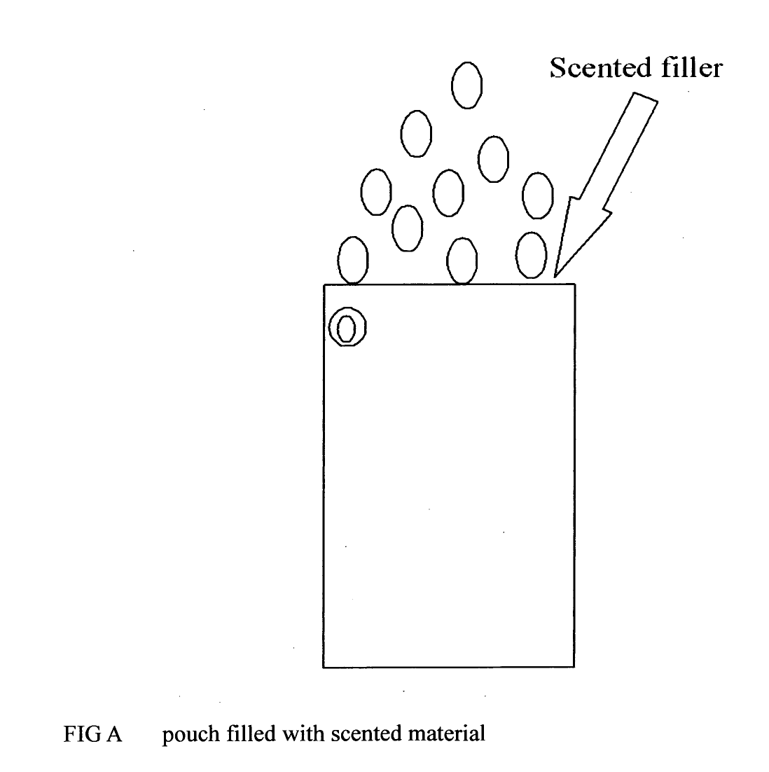

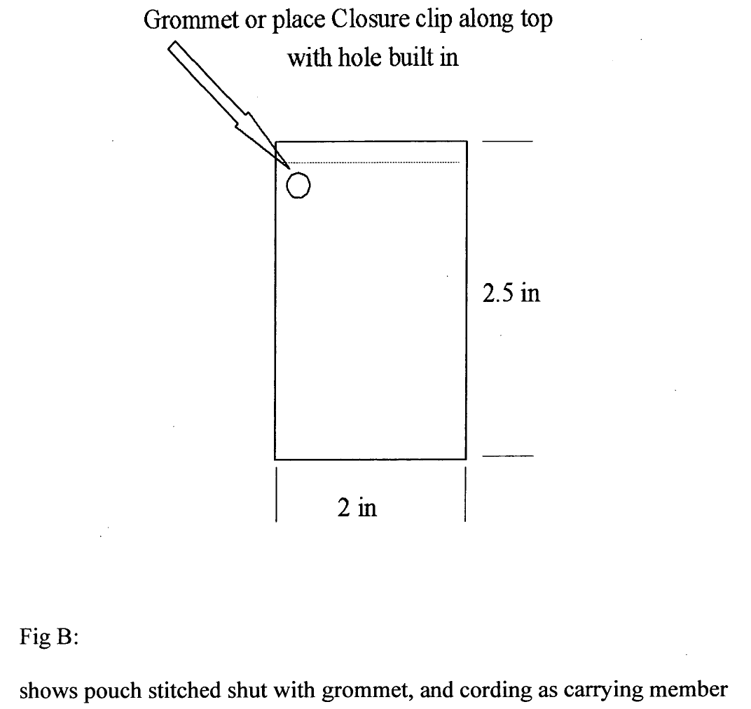

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of the patent will be described in the claims. The order in which steps are listed in the claims does not indicate that the steps must be performed in that order.

The present invention relates to a wearable pouch for people and pets.

An embodiment of the invention keeps bugs such as mosquitoes, gnats, and deer flies off of the person or animal wearing pouch.

An embodiment of the invention can aid in keeping mosquitoes, gnats, deer flies, horse flies, etc., off of people and animals, in a natural way without harmful chemicals, or CFC's. Many items are made from citronella but do not allow the user freedom of total mobility from a close proximity from such products. With natural ingredients and a wearable pouch, it can solve the problem with most insects that fly, by keeping them at a distance from the user. An embodiment allows the user total freedom of mobility; the product can be worn with no limitations on travel.

An embodiment of the current product is good in confined areas. Product can remain stationary and user can be within close proximity to product for it to be effective. It allows user total freedom of mobility; product remains on user until removed and placed back in a zip closure bag.

To make an embodiment, first place 4 pounds of absorbing material such as beads, gel, corn cob, pulverized dried wood, or plastic pellets, in glass, plastic, or metal containers, add 4½ ounces of citronella oil liquid or dried to absorbing material, mix in intervals, and allow to dry.

### SPECIFICATION FOR FIGURE A AND FIGURE B

Fold 5 inch×3 inch fabric in half and sew. (Fig. A) Shows pouch being filled with 2 tablespoons of scented filling. (Fig B) Shows pouch stitched shut, place grommet in upper left corner, cut cording to 1 yard place through grommet, tie knot in end of string/strap or use a carabineer, Finished size is 2 in×2.5 in. Another way of closing could be to use a clamp type of closure with hole in end to place string/strap through or a carabineer. Place pouch and string/strap or carabineer in resealable plastic bag or package such as Ziploc. Place label on package. Other embodiments, instead of cord, use a carabineer with split key ring, or strap as a carrying member.

Absorbing beads, gel, corn cob, pulverized dried wood, plastic pellets contain the scent, citronella oil is essential in the bug detouring effect that it has. The pouch is important to hold the absorbing filler that holds the scent to make it all work together. The cording, strap or carabineer is what allows the user to be mobile by being able to keep it on them at all times while in use. There are other good oils such as lavender, tea tree, or citrus. These oils may also improve the bug detouring capabilities of the pouch.

In other embodiments, the pouch can be made larger to hold more of the absorbing filler to affect a larger area. It could close with hook-and loop, such as Velcro. To make one embodiment, make a holding container out of plastic or fabric that hold the absorbing filler. Use corn starch as a scent absorbing material. State that pouch can be used by people, dogs, horses, cattle, and goats. Design pouch in other fabric forms such as star, circle, triangle, animal looking forms or bug forms. Use a gel type form to hold scent, dried wood, corn cob, plastic pellets. Pouch maybe treated to make them water resistant.

An embodiment works by wearing pouch. It keeps bugs away from user. Absorbing filler contain the scent, the citronella oil is essential in the bug detouring effect that is has, The pouch holds the beads, corn, corn cob, gel, plastic pellets, or pulverized dried wood that hold the scent to make it all work together. The cording, strap, or carabineer is what allows the end user to be mobile while being able to keep it on them at all times.

Embodiments of the invention could be made with commercial mixers with measuring devices. Machines could be used that are automated to cut and sew pouches and fill them, stitch closed or use a clamp type closure with hole in it, or grommet, put cording, strap or on carabineer. Bag them, label them, and box them. They could have an automated step for producing a plastic type container for pouch that is filled with a similar bead or absorbing material such as gel, pulverized dried wood, corn cob, corn, plastic pellets, corn starch, bag them, label and box for shipping.

What is claimed is:

1. A device comprises:
Absorbing beads, corn cob, pulverized dried wood, plastic pellets, gel, corn starch; mixed with dried or liquid citronella oil.
A pouch, containing the absorbing material;
A fastener, adapted to fasten the pouch shut or serge shut;
A grommet on the pouch;
A carrying member, which threads through the grommet or hole;
A resealable type bag;
A label

2. A method making a device comprises:
Placing absorbing beads, corn cob, pulverized dried wood, plastic pellets, gel, cornstarch in a first container;
Adding citronella oil to the absorbing material;
Stirring the container in intervals;
Allowing absorbing material known as filler to dry;
Providing a pouch;
Filling the pouch with the filler;
Closing the pouch;
Placing a grommet or other clamp type closure on the pouch;
Providing a carrying member;
Placing the pouch and carrying member in a second container;
Providing a label; and
Placing the label on the package.
